(19) United States
(12) Patent Application Publication
(10) Pub. No.: US 2019/0297839 A1
(43) Pub. Date: Oct. 3, 2019

(54) MODULAR PET BED

(71) Applicant: 8372683 Canada, Inc., Saint-Laurent (CA)

(72) Inventor: Lorne Miller, Mount Royal (CA)

(21) Appl. No.: 15/941,154

(22) Filed: Mar. 30, 2018

(51) Int. Cl. A01K 1/035; A01K 29/00

(52) U.S. Cl. CPC A01K 1/0353; A01K 29/00

(57) ABSTRACT

A modular pet bet is disclosed that can be readily and easily packaged, shipped, and stored, can be easily cleaned, and is readily and easily portable from one location to another. An illustrative modular pet bed comprises a bottom portion, a wall portion, a plurality of wall cushions, and an inside cushion.

### BACKGROUND

### Field of the Invention

This invention relates to a pet bed and in particular to a modular pet bed.

### Background Information

Household pets are family members that deserve comfortable accommodations for resting and sleeping. Pet beds often have surrounding wall portions that provide security and comfort to the pet. Typically, the wall portions extend upwardly from the perimeter of the pet bed, leaving an opening through which the animal can enter and leave, and allowing the animal to see over the wall and out even while resting. Pets can also use the wall portion as a headrest to feel safer with a better view of their surroundings. However, for larger and heavier pets the wall portions of the pet bed have to be manufactured from thicker and sturdier foam to support the head of the larger animal when the wall portion is used as a headrest. A pet bed having wall portions made from thick and sturdy foam weighs more and is more cumbersome to ship, store, and transport than a pet bed with lighter walls for lighter and smaller pets.

In addition, since pets commonly carry pests, those pests can infiltrate the pet bed. Similarly, any dirt and oils from the pet's body are transferred to the pet bed. Since a pet bed containing thick foam cannot be effectively cleaned, it must periodically be discarded to eliminate any pest infestation or when an unacceptable level of soil or odor accumulates. Discarding and replacing pet beds on a frequent basis can become expensive.

Further, most present pet beds are not well adapted to online shopping. Thick and sturdy foam walls that are permanently attached to the pet bed are cumbersome to store in a warehouse and use the available storage space inefficiently. Moreover, the size of the shipping box required to ship the pet beds to a customer makes shipping expensive.

### SUMMARY

The disadvantages of the prior art are overcome by providing a modular pet bed that can be readily and easily packed and shipped, can be easily cleaned, and is readily and easily portable from one location to another. An illustrative modular pet bed comprises a bottom portion, a wall portion, a plurality of wall cushions, and an inside cushion. The bottom portion may consist of tear-resistant fabric or a waterproof material and support the inside cushion. Further, the bottom portion may give the modular pet bed its shape. The wall portion may be attached to the bottom portion.

The wall portion may be a hollow fabric cover that is tear-resistant and odor-proof and may house the plurality of wall cushions. The wall portion may illustratively surround the perimeter of the bottom portion, leaving an opening through which the pet can enter and leave. The wall portion may further include a securing mechanism/device utilized to open and close the wall portion.

The plurality of wall cushions may illustratively be manufactured in a way that the wall cushions can be inserted into the hollow wall portion of the modular pet bed and fill the void of the hollow wall portion. In an exemplary embodiment, the modular pet bed may have three wall cushions. A first wall cushion may be inserted into a front wall portion to the left of the opening and may be angled such that it extends into a left wall portion. A second wall cushion may be inserted into a rear wall portion. A third wall cushion may be inserted into the front wall portion to the right of the opening and may be angled such that it extends into a right wall portion. The plurality of wall cushions may illustratively be manufactured and shaped such that the cushions fill the hollow wall portion when fully inserted. The plurality of wall cushions may also be manufactured and shaped such that the wall cushions can be secured in place and fully encased by closing of the securing mechanism/device of the wall portion.

The modular pet bed's inside cushion may illustratively be a hollow fabric cover covering an insert. Alternatively, the inside cushion may only include the insert. The insert may comprise a foam core or a foam core covered with fabric and may further include a patch pocket which may, for example, accommodate a pouch or packet containing a scented material. To improve the odor of the modular pet bed, the pouch or packet with the scented material may also be affixed to the insert or inside cushion in any of a variety of ways, or it may be affixed to another part of the modular pet bed. The hollow fabric cover of the inside cushion may fully encase the insert, and the insert may fill the hollow fabric cover when inserted. The insert may be manufactured and shaped such that the insert can be secured in place by closing a securing mechanism/device of the hollow fabric cover. If the insert has a foam core covered with fabric, the insert may also comprise an additional securing mechanism/device so that the foam core can be secured in place within the fabric.

The pet bed is highly modular and therefore allows for easy packing and cleaning. In an illustrative embodiment, a manufacturer or vendor of the modular pet bed may remove the wall cushions and the inside cushion to pack and ship the modular pet bed. For example, a noted advantage of the modular pet bed is that it may be stored and/or shipped in a vacuum-sealed container to conserve space. Further, in an embodiment, the pet owner may remove the wall cushions and the inside cushion to transport the modular pet bed or to store it when not in use. The user may also remove the insert or foam core of the inside cushion. Removing the cushions, insert, and/or foam core allows for easy cleaning as the fabric of the bottom portion, the wall portion fabric cover, and the fabric cover of the inside cushion may be washed.

### BRIEF DESCRIPTION OF THE DRAWINGS

The description below refers to the accompanying drawings, of which:

FIG. 1 is a front oblique view of a modular pet bed;

FIG. 2 is a front oblique view of a modular pet bed with the inside cushion removed;

FIG. 3A is a front oblique view of an inside cushion;

FIG. 3B is a rear oblique view of an inside cushion;

FIG. 3C is a rear oblique view of an inside cushion insert;

FIG. 4 is a top oblique view of an illustrative example of a plurality of wall cushions; and

FIG. 5 is a front oblique view of a modular pet bed including wall portion and securing mechanism/device.

### DETAILED DESCRIPTION OF AN ILLUSTRATIVE EMBODIMENT

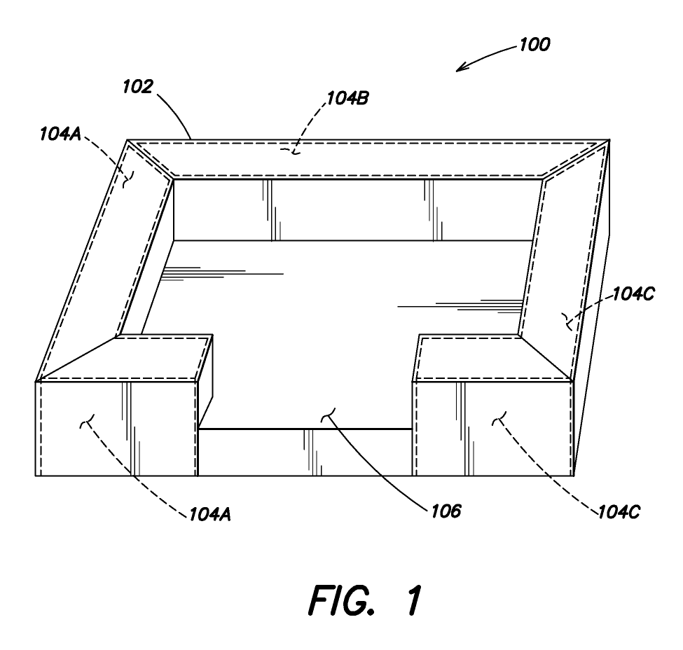

FIG. 1 shows a representative front oblique view of an exemplary embodiment of a modular pet bed 100. The modular pet bed 100 comprises a wall portion 102 that houses a plurality of wall cushions 104A-C. The wall cushions 104A-C may illustratively be manufactured from a foam material or a foam material encased in fabric. The wall portion 102 may be a cover made from a continuous piece of fabric to give the appearance of a single wall cushion. Illustratively, the wall portion 102 may have a securing mechanism/device, such as, but not limited to, a zipper, strings, buttons, magnets, hook and loop fasteners such as Velcro®, clips, etc. (not shown in FIG. 1) that runs along a perimeter of the bottom portion of the modular pet bed to close the wall portion 102 after the wall cushions 104A-C have been inserted into the wall portion 102. Further, the modular pet bed 100 may have an inside cushion 106. An exemplary inside cushion 106 may be a hollow fabric cover including an insert. Alternatively, the inside cushion 106 may only include the insert. The exemplary inside cushion 106 may also include a securing mechanism/device, such as, but not limited to, a zipper, strings, buttons, magnets, hook and loop fasteners such as Velcro®, clips, etc. (not shown in FIG. 1). It is noted that the modular pet bed 100 may be stored and/or shipped in a vacuum-sealed container (not shown in FIG. 1). Advantageously, space is conserved during storage and/or shipping.

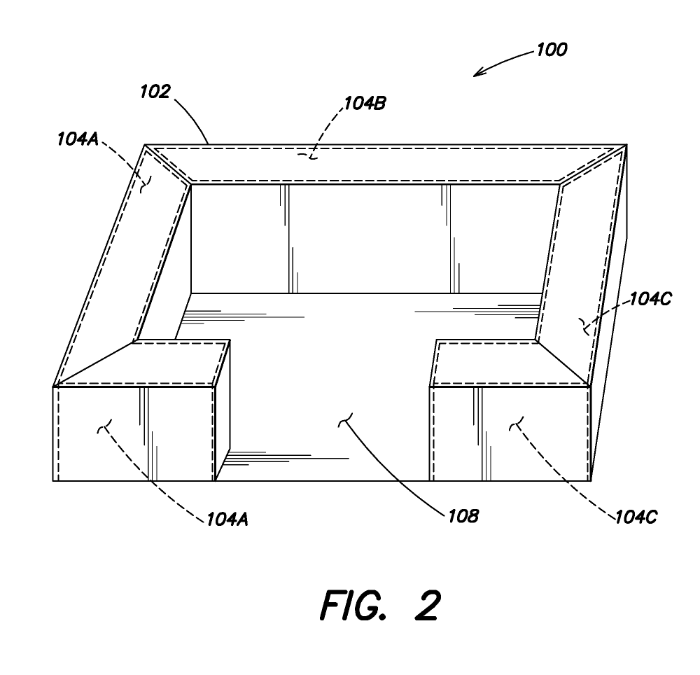

FIG. 2 shows a representative front oblique view of an exemplary embodiment of the modular pet bed 100 with the inside cushion 106 removed. The modular pet bed 100 illustratively comprises the wall portion 102 housing the wall cushions 104A-C. The modular pet bed 100 also comprises a bottom portion 108. The bottom portion 108 may illustratively support the inside cushion 106 (removed and not shown in FIG. 2). As can be seen in FIG. 2, the wall portion 102 may be placed along the perimeter of the bottom portion 108 and may be attached to the perimeter of the bottom portion 108, leaving an opening on one side for the animal to enter and leave the modular pet bed 100. The opening may illustratively be in the front, but it may also be located on any of the other sides. In alternate embodiments, the modular pet bed 100 may have more than one opening. The bottom portion 108 may be manufactured from a material that is easy to clean, such as, but not limited to, plastic, vinyl, and/or a heavy-weight material. The bottom portion 108 may also be manufactured from an anti-slip material or have an anti-slip bottom.

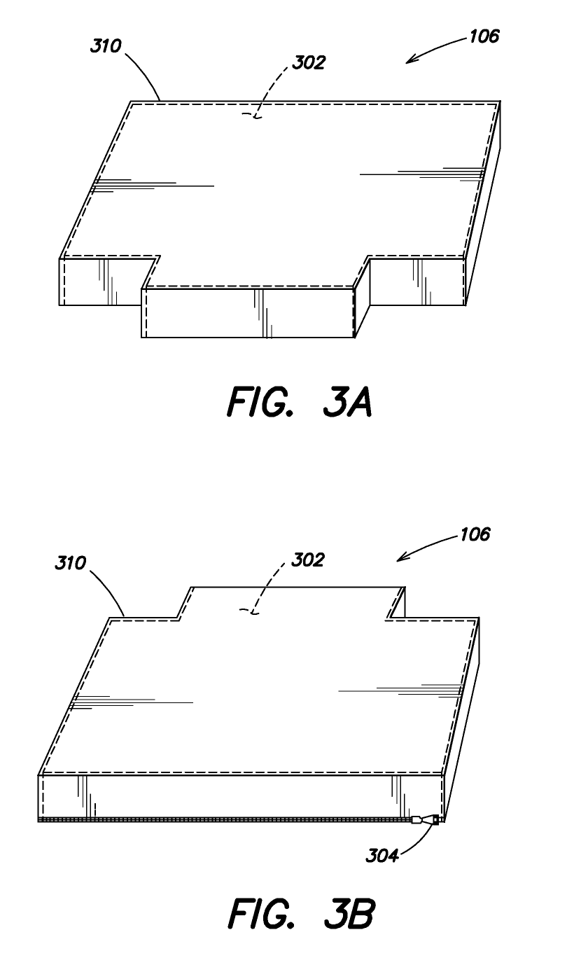

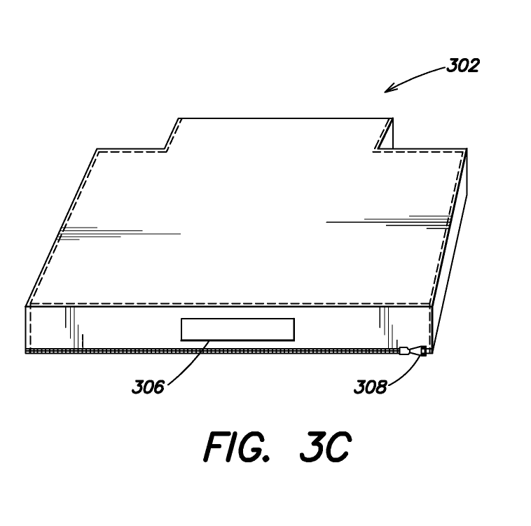

FIGS. 3A and 3B show a front and rear oblique view of an exemplary embodiment of the inside cushion 106. The inside cushion 106 may illustratively be a hollow fabric cover 310 and inside cushion insert 302. Although reference is made to the inside cushion 106 including hollow the fabric cover 310, it is expressly contemplated that inside cushion 106 may only include the insert 302. Exemplarily, the hollow fabric cover 310 of the inside cushion 106 houses the insert 302, and the insert 302 may fill the hollow fabric cover 310 when fully inserted. The hollow fabric cover 310 also may include a securing mechanism/device, such as zipper 304 along one or more sides to provide the user with access to insert 302 for cleaning, for example. Alternatively, the hollow fabric cover 310 may include a different kind of fastener or no fastener at all. The inside cushion 106 may illustratively be manufactured from a material that is easy to clean, such as, but not limited to, a plastic or vinyl material. The inside cushion 106 may also be manufactured from a material that is tear-resistant and odor-proof, such as a faux suede material.

FIG. 3C shows a rear oblique view of the cushion insert 302. The cushion insert 302 may be manufactured from fabric encasing a foam core. Alternatively, the cushion insert 302 may comprise a foam core without fabric or may be manufactured from a different material. The cushion insert 302 may further comprise a patch pocket 306. The patch pocket 306 may illustratively hold a pouch or packet containing a scented material. Illustratively, the pouch or packet may have a lavender scent or any of a variety of different scents. The user can insert the pouch or packet into the patch pocket 306 to give the inside cushion, and thus the modular pet bed 100, a desired scent or to mask any undesirable scent that may be present in the area of the modular pet bed 100. When the scent pouch or packet in the patch pocket 306 has lost its potency or the user desires a different scent, the user can replace the pouch or packet by removing it from the patch pocket 306 and inserting a new pouch or packet. In addition or alternatively, one or more pouches or packets containing a scented material may also be affixed to the insert 302 or inside cushion 106 (not shown in FIG. 3C) in any of a variety of ways, or they may be affixed to other parts of the modular pet bed 100. Exemplarily, the cushion insert 302 may additionally comprise a securing mechanism/device, such as zipper 308 along one or more sides of the insert. The zipper 308 allows for removal of the foam core from the cushion insert 302, e.g., for washing or cleaning. Alternatively, the cushion insert 302 may include a different kind of securing mechanism/device, such as, but not limited to, strings, buttons, magnets, hook and loop fasteners such as Velcro®, clips, etc., or no fastener at all.

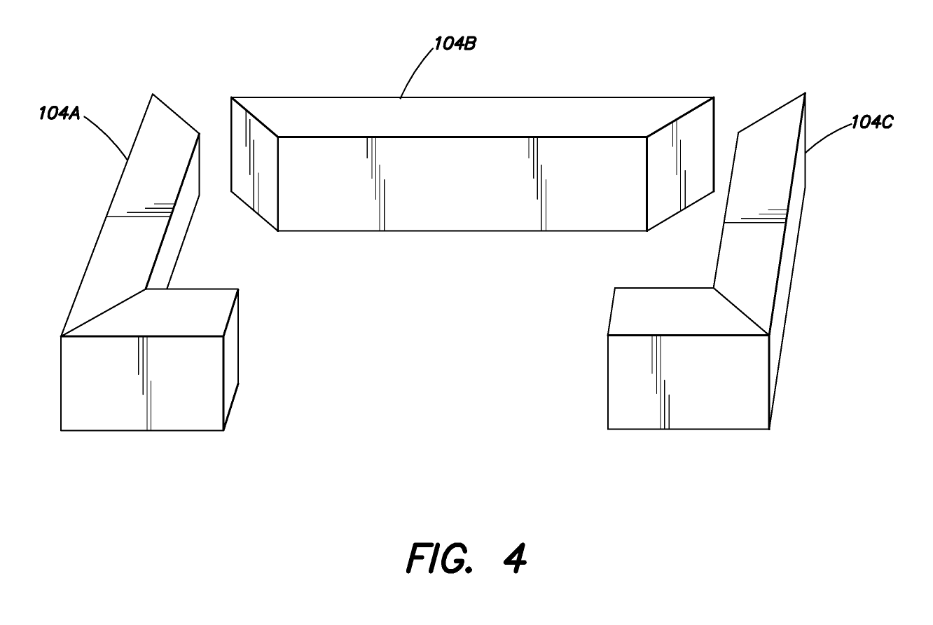

FIG. 4 shows a top oblique view of an exemplary embodiment of the plurality of wall cushions 104A-C that may be placed inside the wall portion 102 (not shown in FIG. 4). The plurality of wall cushions 104A-C allows for modularity and gives the user a convenient option to remove the wall cushions. Exemplarily, the plurality of wall cushions 104A-C may comprise a foam piece 104A for the left part of the front wall portion and the left wall portion, a foam piece 104B for the rear wall portion, and a foam piece 104C for the right part of the front wall portion and the right wall portion. It should be noted that the use of three wall cushions is for illustrative purposes only and that the plurality of wall cushions 104A-C may consist of fewer or more than three foam pieces. In addition, the foam pieces that make up the plurality of wall cushions 104A-C may have different shapes and may be arranged in a different combination than what is shown in FIG. 4. Illustratively, the wall cushions that form the plurality of wall cushions 104A-C may be manufactured from a foam material, from a foam material encased in fabric, or from a variety of different materials.

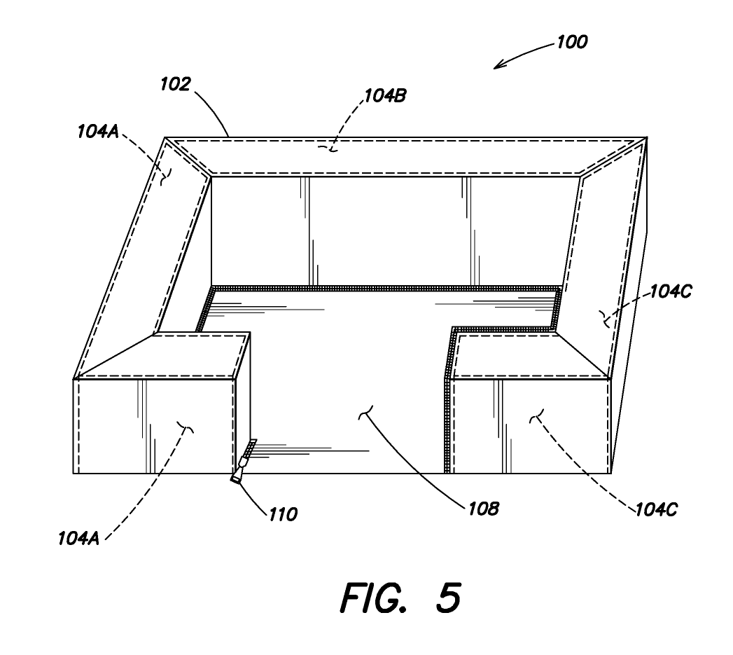

FIG. 5 shows a front oblique view of an exemplary embodiment of the modular pet bed 100 comprising the wall portion 102 and the bottom portion 108. The wall portion 102 may illustratively house the plurality of wall cushions 104A-C and comprise a securing mechanism/device, such as zipper 110. The plurality of wall cushions 104A-C may illustratively be manufactured and shaped such that the cushions fill the hollow wall portion 102 when fully inserted. Illustratively, the zipper 110 may be attached to the perimeter of the bottom portion 108. When the zipper 110 is open, the user may insert the wall cushions 104A-C into the wall portion 102 to allow for the wall portion 102 to extend upwardly from the perimeter of the bottom portion 108. The plurality of wall cushions 104A-C may fill the wall portion 102 when fully inserted and give the wall portion 102 its shape. Closing the zipper 110 secures the wall cushions 104A-C in place and provides a protective cover by encasing the wall cushions 104A-C in the wall portion 102. The zipper 110 further provides the user with a convenient way to remove the plurality of wall cushions 104A-C for cleaning, packing, shipping, or storing of the modular pet bed. The wall portion 102 may illustratively be manufactured from a material that is easy to clean, such as a plastic or vinyl material. The wall portion 102 may also be manufactured from a material that is tear-resistant and odor-proof, such as a faux suede material. Advantageously, the arrangement of placing the wall cushions 104A-C into the hollow wall portion 102 allows not only for easy cleaning of the modular pet bed 100 by removing the plurality of wall cushions 104A-C, but also for easy shipping, packing, moving, and storage. Specifically, the modular pet bed 100 may be stored flat or folded when the plurality of wall cushions 104A-C has been removed from the wall portion 102.

The foregoing description has been directed to specific illustrative embodiments. However, it will be apparent that other variations and modifications may be made to the described embodiments, with the attainment of some or all of their advantages. Specifically, various configurations, sizes, and materials have been described. It is expressly noted that all such descriptions should be taken as exemplary only and not limiting the invention. Therefore, it is the object of the appended claims to cover all such variations and modifications as come within the true spirit and scope of the invention.

What is claimed is:

1. A modular pet bed, comprising:
a bottom portion having a perimeter;
a hollow wall portion attached to the perimeter of the bottom portion, wherein the hollow wall portion surrounds the perimeter of the bottom portion and has an opening; and
an inside cushion supported by the bottom portion,
wherein the hollow wall portion houses a plurality of wall cushions and wherein the hollow wall portion has a first securing mechanism along the perimeter of the bottom portion configured to open and close the hollow wall portion.

2. The modular pet bed of claim 1 wherein the plurality of wall cushions comprises at least three cushions.

3. The modular pet bed of claim 1 wherein the opening of the wall portion is in a front of the modular pet bed.

4. The modular pet bed of claim 1 wherein the bottom portion has an anti-slip bottom.

5. The modular pet bed of claim 1 wherein the hollow wall portion is manufactured from a faux suede material.

6. The modular pet bed of claim 1 wherein the hollow wall portion is manufactured from a plastic or vinyl material.

7. The modular pet bed of claim 1 wherein each wall cushion of the plurality of wall cushions comprises a foam core.

8. The modular pet bed of claim 1 wherein each wall cushion of the plurality of wall cushions is encased by fabric.

9. The modular pet bed of claim 1 wherein the first securing mechanism is selected from a zipper, buttons, magnets, strings, clips, and a hook and loop fastener.

10. The modular pet bed of claim 1 wherein the inside cushion includes at least an inside cushion insert.

11. The modular pet bed of claim 10 wherein the inside cushion further includes a hollow fabric cover and wherein the hollow fabric cover has a second securing mechanism along one or more sides of the inside cushion configured to open and close the hollow fabric cover.

12. The modular pet bed of claim 11 wherein the second securing mechanism is selected from a zipper, buttons, magnets, strings, clips, and a hook and loop fastener.

13. The modular pet bed of claim 10 wherein the inside cushion insert comprises a foam core and an insert cover.

14. The modular pet bed of claim 13 wherein the inside cushion insert further comprises a patch pocket attached to the insert cover.

15. The modular pet bed of claim 14 wherein the patch pocket is configured to hold a pouch or packet containing a scented material.

16. The modular pet bed of claim 15 wherein the scented material has a scent of lavender.

17. The modular pet bed of claim 1 wherein the inside cushion is manufactured from a faux suede material.

18. The modular pet bet of claim 1 wherein the inside cushion is manufactured from a plastic or vinyl material.

19. The modular pet bed of claim 13 wherein the inside cushion insert further comprises a third securing mechanism along one or more sides of the insert cover configured to open and close the insert cover.

20. The modular pet bed of claim 19 wherein the third securing mechanism is selected from a zipper, buttons, magnets, strings, clips, and a hook and loop fastener.
